(19) United States
(12) Patent Application Publication
(10) Pub. No.: US 2026/0181330 A1
(43) Pub. Date: Jun. 25, 2026

(54) Speaker Module

(71) Applicant: AAC Kaitai Technologies (Wuhan) CO., LTD., Wuhan (CN)

(72) Inventors: Yu Shen, Wuhan (CN); Qiang Dan, Wuhan (CN); Yiwei Zhou, Wuhan (CN); Yang Li, Wuhan (CN)

(21) Appl. No.: 19/363,614

(22) Filed: Oct. 20, 2025

Related U.S. Application Data
(63) Continuation of application No. PCT/CN2024/140607, filed on Dec. 19, 2024.

(51) Int. Cl. H04R 7/12; H04R 1/02; H04R 17/00

(52) U.S. Cl. CPC H04R 7/122; H04R 1/025; H04R 17/00; H04R 2201/003

(57) ABSTRACT

A speaker module includes a first MEMS speaker and a second MEMS speaker disposed at two opposite surfaces of a circuit board and mounted in a flipped manner; the first MEMS speaker including a first diaphragm structure electrically connected to a first electrode connection point and is controlled by the circuit board to vibrate; the second MEMS speaker including a second diaphragm structure electrically connected to a second electrode connection point and is controlled by the circuit board to vibrate.

### FIELD

The present disclosure relates to electroacoustic technologies, and more particularly relates to a speaker module.

### BACKGROUND

A speaker is a transducing device converting an electrical signal to an acoustic signal or vice versa. The speaker operates on a principle that due to electromagnetic, piezoelectric, or electrostatic effect, electrical energy of an audio drives a diaphragm or cone to vibrate in resonance with the ambient air to produce sound.

Sound is produced by fluctuations of pressure in the air. A speaker pushes a certain amount of air to cause fluctuations of pressure, whereby a certain sound is emitted (sound pressure). Currently, due to a miniaturized structure design, an existing speaker module generally includes a speaker structure, where sound pressure is controlled through controlling effective radius, frequency, distance, and one-way stroke of the diaphragm inside the speaker structure. However, the existing speaker module only realizes miniaturization, but fails to give due consideration to output power, which leads to insufficient sound pressure and limited functions.

### SUMMARY

To address the above problems, the present disclosure mainly provides a speaker module, which enables arrangement of two speaker structures inside the speaker module without changing the current miniaturization design so as to realize a speaker module with a higher sound pressure by flexible control of the two speaker structures.

A technical solution of the present disclosure provides a speaker module, the speaker module including: a housing enclosing a cavity, the housing having a sound outlet hole running through a thickness of the housing; a circuit board disposed in the cavity, the circuit board having a first surface and a second surface which are oppositely set, the first surface having a first electrode connection point, the second surface having a second electrode connection point; a first MEMS (Micro-Electro Mechanical System) speaker disposed in the cavity, the first MEMS speaker being mounted on the first surface in a flipped manner, the first MEMS speaker including a first diaphragm structure, the first diaphragm structure being electrically connected to the first electrode connection point, the first diaphragm structure being controlled by the circuit board to vibrate; and a second MEMS (Micro-Electro Mechanical System) speaker disposed in the cavity, the second MEMS speaker being mounted on the second surface in a flipped manner, the second MEMS speaker including a second diaphragm structure, the second diaphragm structure being electrically connected to the second electrode connection point, the second diaphragm structure being controlled by the circuit board to vibrate.

Optionally, the first MEMS speaker further includes: a first substrate enclosing a first cavity, the first diaphragm structure stacked on top of the first substrate and covering the first cavity, and a flexible structure layer overlaid on the first diaphragm structure; and the first diaphragm structure is a piezoelectric compound diaphragm.

Optionally, the second MEMS speaker further includes: a second substrate enclosing a second cavity, the second diaphragm structure being stacked on top of the second substrate and covering the second cavity, and a flexible structure layer overlaid on the second diaphragm structure; and the second diaphragm structure is a piezoelectric compound diaphragm.

Optionally, the first diaphragm structure includes a plurality of sub-diaphragms, a slit being present between adjacent sub-diaphragms; and the first flexible structure layer covers the slit completely.

Optionally, an underside of the first substrate has a three-dimensional hexagonal structure; and an underside of the first diaphragm structure has a three-dimensional hexagonal structure.

Optionally, the first diaphragm structure includes six sub-diaphragms, each of the sub-diaphragms having a polygonal structure extending from an edge of the first substrate towards a central point of the first substrate, top portions of the six polygonal structures facing the central point, a bottom edge of each of the polygonal structures being rested on the first substrate.

Optionally, each polygonal structure is a three-dimensional isosceles triangle structure, a vertex of each isosceles triangle pointing the central point.

Optionally, the first flexible structure layer is an organic thin film layer.

Optionally, the first diaphragm structure includes a support layer, a bottom electrode layer, a piezoelectric layer, a top electrode layer, and a protective layer which are stacked together; and the support layer is spaced apart from the first flexible structure layer.

Optionally, a through-hole is provided in a center of the circuit board, and the through-hole has a polygonal or circular shape.

The present disclosure offers the following benefits: the speaker module according to the present disclosure is a two-way driven speaker module; the first MEMS speaker and the second MEMS speaker at two sides of the circuit board may be driven by different drive signals, so that the vibration direction of the first diaphragm structure is opposite the vibration direction of the second diaphragm structure at a same time, whereby the sound waves produced by the air pushed by the first MEMS speaker and the second MEMS speaker are superimposed at the sound outlet hole, which may improve the sound pressure level performance of the speaker; secondly, the vibration direction of the first diaphragm structure is identical to the vibration direction of the second diaphragm structure at another time, so that the sound waves produced by the air pushed by the first MEMS speaker and the second MEMS speaker are offset at the sound output hole, which realizes a more flexible control.

### BRIEF DESCRIPTION OF THE DRAWINGS

To illustrate the technical solutions in the embodiments of the disclosure more clearly, the drawings referred to in describing the embodiments will be introduced briefly. It is apparent that the drawings provided below are only some embodiments of the disclosure, and to those skilled in the art, other drawings may also be derived based on these drawings without exercise of inventive work, in which:

FIG. 1 is a structural schematic diagram of a speaker module according to some implementations of the present disclosure;

FIG. 2 is an exploded view of the speaker module shown in FIG. 1;

FIG. 3 is a sectional view of the speaker module shown in FIG. 1;

FIG. 4 is a structural schematic diagram of a first MEMS speaker in the speaker module shown in FIG. 1;

FIG. 5 is a sectional stereoscopic view of the first MEMS speaker in the speaker module shown in FIG. 1;

FIG. 6 is a local sectional view of a first diaphragm structure in the first MEMS speaker shown in FIG. 1;

FIG. 7 is a structural schematic diagram of a second MEMS speaker in the speaker module shown in FIG. 1;

FIG. 8 is a sectional stereoscopic view of the second MEMS speaker in the speaker module shown in FIG. 1.

### DETAILED DESCRIPTION OF EMBODIMENTS

To make the objectives, features, and advantages of the embodiments of the present disclosure more elucidated, various implementations of the disclosure will be described in detail with reference to the accompanying drawings. A person of normal skill in the art may understand, many technical details are provided herein to help readers better understand the present disclosure; however, various alterations and modifications based on the implementations described hereinafter even without these technical details can also implement the technical solutions sought for protection in the present disclosure.

In the implementations of the disclosure, the orientational or positional relationships indicated by the terms “upper”, “lower”, “left”, “right”, “front”, “rear”, “top”, “bottom”, “inner”, “outer”, “central”, “vertical”, “horizontal”, “transverse”, “longitudinal”, and etc. are orientational and positional relationships based on the drawings, which are intended only for facilitating description of the disclosure and its implementations, not for indicating or implying that the devices or elements compulsorily possess those specific orientations and are compulsorily configured and operated with those specific orientations; therefore, such terms should not be construed as limitations to the disclosure.

Moreover, in addition to indicating the orientational or positional relationships, some of the above terms may also have other meanings. For example, the term “upper” may also indicate some attachment relationship or connection relationship in some cases. For a person of normal skill in the art, specific meanings of these terms referred to therein may be understood dependent on specific situations.

In addition, the terms “mount”, “disposed”, “provided with”, “set”, “connect”, and “attach” should be understood broadly, which, for example, may refer to a fixed connection, a detachable connection, or an integral connection; which may be a mechanical connection or an electrical connection; which may be a direct connection or an indirect connection via an intermediate medium; which may also be a communication between the insides of two elements or an interaction between two elements. To a person of normal skill in the art, specific meanings of the above terms in the disclosure may be construed dependent on specific situations.

Besides, the terms such as “first” and “second” are only used for distinguishing different devices, elements or components (specific types and structures may be identical or different), which shall not be construed as indicating or implying relative importance or quantity of a referred to device, element or component. Unless otherwise indicated, “plurality” indicates two or above.

Hereinafter, various implementations of the present disclosure will be described in detail with reference to the accompanying drawings. A person of normal skill in the art may understand, in various implementations of the present disclosure, many technical details are provided herein to help readers better understand the present disclosure; however, various alterations and modifications based on the implementations described hereinafter even without these technical details can also implement the technical solutions sought for protection in the present disclosure.

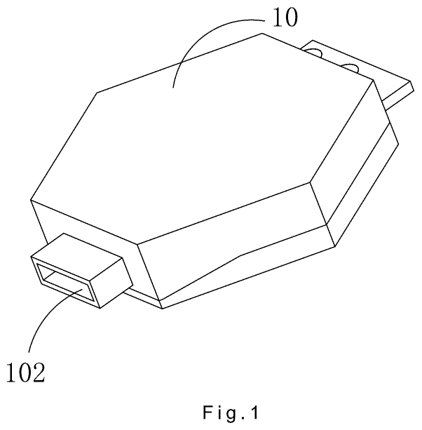

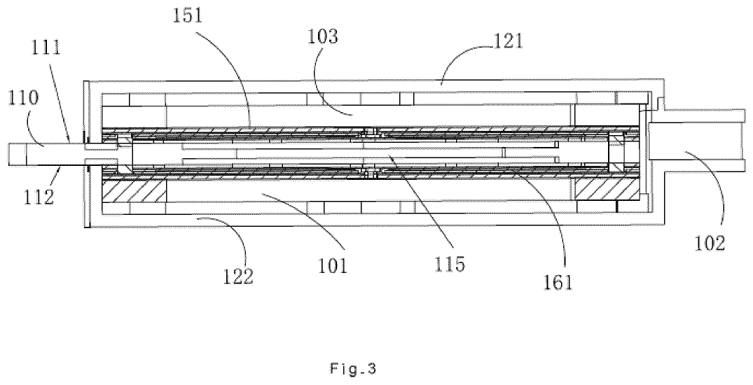

FIGS. 1-8 illustrate a speaker module according to an implementation of the present disclosure. The speaker module includes: a housing 10, the housing 10 enclosing a cavity, the housing 10 having a sound outlet hole 102 running through a thickness of the housing 10; a circuit board 110 disposed in the cavity, the circuit board 110 having a first surface 111 and a second surface 112 which are oppositely set, the first surface 111 having a first electrode connection point 113, the second surface 112 having a second electrode connection point; a first MEMS (Micro-Electro Mechanical System) speaker 150 disposed in the cavity, the first MEMS speaker 150 being mounted on the first surface 111 in a flipped manner, the first MEMS speaker 150 including a first diaphragm structure 151, the first diaphragm structure 152 being electrically connected to the first electrode connection point 113, the first diaphragm structure 151 being controlled by the circuit board 110 to vibrate; and a second MEMS speaker 160 disposed in the cavity, the second MEMS speaker 160 being mounted on the second surface 112 in a flipped manner, the second MEMS speaker 160 including a second diaphragm structure 161, the second diaphragm structure 161 being electrically connected to the second electrode connection point, the second diaphragm structure 161 being controlled by the circuit board 110 to vibrate.

The housing 10 of the speaker module provides physical protection and meanwhile reduces attenuation to desired sound to the utmost extent.

Referring to FIGS. 1 to 3, the housing 10 includes a first housing 121 and a second housing 122 which are snap-fitted with each other, the first housing 121 and the second housing 122 defining a first sub-cavity 101 and a second sub-cavity 103, respectively, the first sub-cavity 101 and the second sub-cavity 103 jointly constituting the cavity.

An acoustic port is provided on the housing 10, the acoustic port being configurable to balance pressure between the first sub-cavity 101/second sub-cavity 103 and the ambience. The present disclosure does not limit the number or shape of the acoustic port, which may be set by a person of normal skill in the art based on actual needs.

The housing 10 is provided thereon with two opposite through-holes, one through-hole serving as the sound outlet hole 102, the other one serving as a connecting terminal of the circuit board.

In one implementation, the circuit board 110 may run through the through-hole on the housing as illustrated in FIG. 1, circuit connection points (e.g., a first circuit connection point and a second circuit connection point) being provided on a surface of the circuit board 110, the circuit connection points being configurable to connect external circuit elements and transmit a first signal and a second signal, the first signal being configurable to control the first diaphragm structure 151 to vibrate, the second signal being configurable to control the second diaphragm structure 161 to vibrate.

It is noted that, although the through-hole where the circuit board 110 is disposed is directly opposite the sound outlet hole 102 in the housing 10, as illustrated in FIG. 1, it is optional that the through-hole where the circuit board 110 is located and the sound outlet hole 102 may be arranged on different sides of the housing 10 or on another base satisfying design requirements.

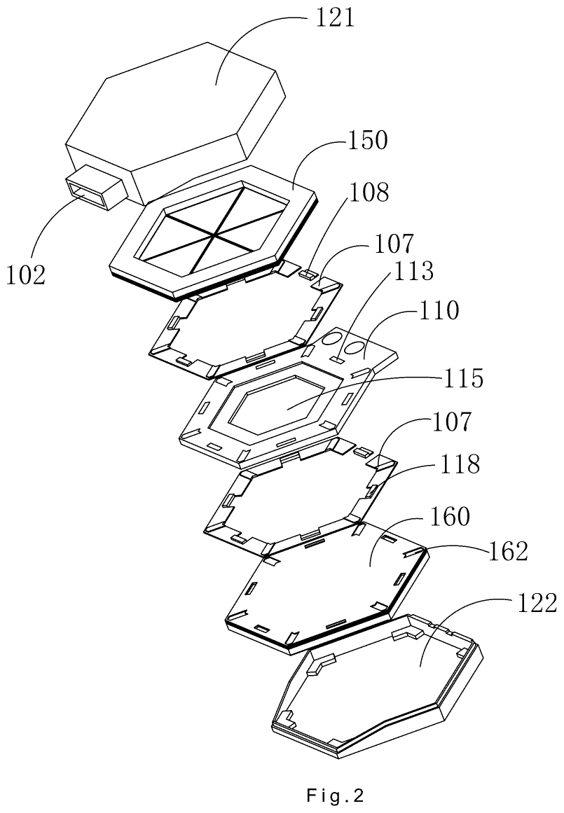

Referring to FIG. 2, the circuit board 110 according to this implementation is provided with a through-hole 115 in its center, or the circuit board 110 is formed of a ring shape, e.g., a square ring or a circular ring. The through-hole 115 runs through a thickness of the circuit board 110, the through-hole 115 being directly opposite and extending through the first cavity 154 of the first MEMS speaker 150 and a second cavity 164 of the second MEMS speaker 160, respectively. The through-hole 115 may serve as a vibration space for the first diaphragm structure 151 and a second vibration space for the second diaphragm structure 161.

The through-hole 115 has a polygonal shape or a circuit shape. The polygonal shape may be square, triangular, hexagonal, or octagonal, or any arbitrary shape.

The flipped mounting manner refers to directly flipping the first MEMS speaker 150 upside down to connect it onto the circuit board 110 via a bump (a third electrode connection point) on the first MEMS speaker 150 and directly flipping the second MEMS speaker 160 upside down to connect it onto the circuit board 110 via a bump (a third electrode connection point) on the second MEMS speaker 160; this flipped mounting manner may reduce the planar footprints of the first MEMS speaker 150 and the second MEMS speaker 160, thereby saving space and achieving miniaturization.

Referring to FIG. 4, the first MEMS speaker 150 further includes: a first substrate 153 enclosing a first cavity 154, a first diaphragm structure 151 stacked on top of the first substrate 153 and covering the first cavity 154, and a first flexible structure layer 157 overlaid on the first diaphragm 151; the first diaphragm structure 151 is a piezoelectric compound diaphragm.

A bottom of the first substrate 153 of the first MEMS speaker 150 may have a circular shape, a square shape, a hexagonal shape, an octagonal shape, or any arbitrary equilateral shape.

In this implementation, an underside of the first substrate 153 of the first MEMS speaker 150 has a three-dimensional hexagonal structure, the first substrate 153 is formed in a hexagonal ring shape, and the first diaphragm structure 151 and the first substrate 153 enclose the first cavity 154, the first cavity 154 extending through the first substrate 153 to serve as a vibration space for the first MEMS speaker 150. Optionally, the first substrate 153 may be a monocrystalline silicon base or another type of base satisfying design requirements.

In this implementation, when the first substrate 153 is has a hexagonal ring shape, the edges of the inner sides and outer sides as well as the joints of the first substrate 153 are chamfered, particularly filleted, which may reduce the sharp structures inside the first MEMS speaker 150, which facilitates product assembly and meanwhile may prevent the sharp structures on the first substrate 153 from potentially contacting and damaging other internal devices of the first MEMS speaker 150.

The underside of the first diaphragm structure 151 may have a round shape, a square shape, a hexagonal shape, an octagonal shape or any arbitrary equilateral shape. The underside of the first diaphragm structure 151 is a three-dimensional hexagonal structure in correspondence to the shape of the first substrate 153.

Optionally, the first diaphragm structure 151 includes a plurality of sub-diaphragms 1511, a slit 155 being present between adjacent sub-diaphragms 1511. For example, the first diaphragm structure includes 4, 5, 6, or another number of sub-diaphragms. Of course, to those skilled in the art, the number and shape of the first substrates may be set dependent on actual needs.

The first diaphragm structure 151 includes six sub-diaphragms 1511, each diaphragm 1511 having a polygonal structure extending from edges of the first substrate 153 towards the central point of the first substrate 153, the top portions of the six polygonal structures facing the central point, bottom edges of respectively polygonal structures being rested on the first substrate 153.

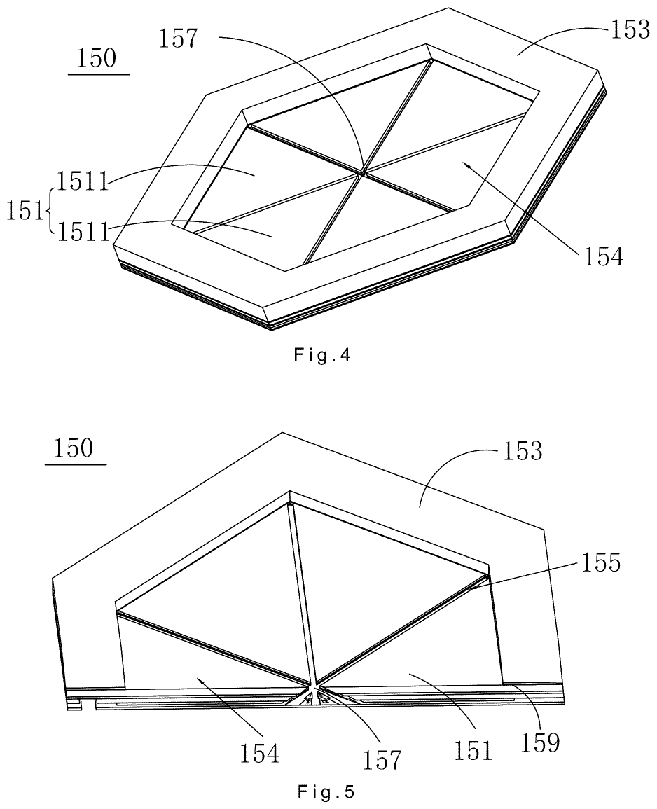

FIGS. 4 and 5 illustrate an example that the first diaphragm structure 151 includes six sub-diaphragms 1511. Each sub-diaphragm 1511 has a three-dimensional isosceles triangle structure, respective vertices of the six isosceles triangles facing the central point of the first substrate 153 and enclosing a hexahedral structure, the bottom edge of each isosceles triangle being rested on the first substrate 153; and the first cavity 154 formed by the first substrate 153 also has a hexahedral structure.

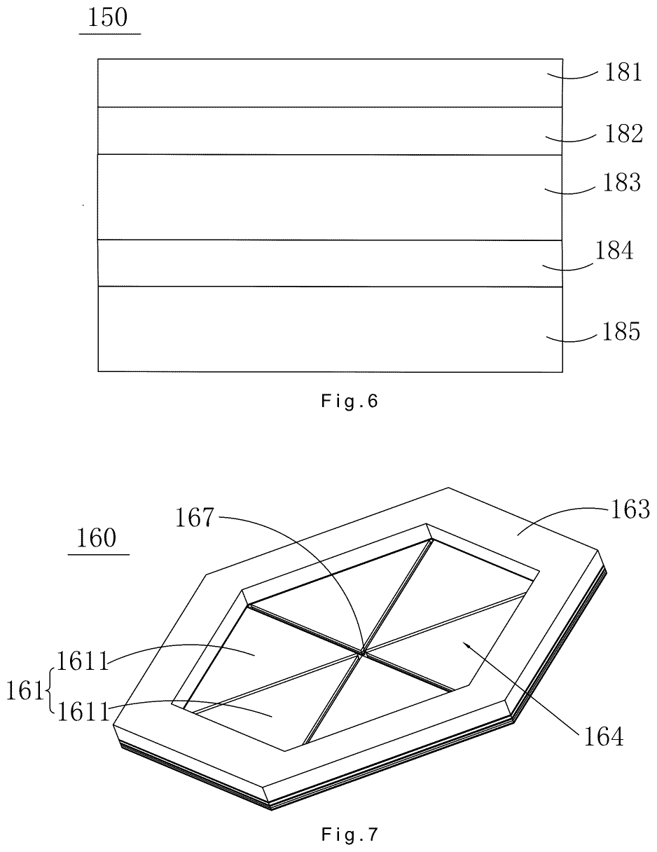

Optionally, referring to FIG. 6, the first diaphragm structure 151 includes a support layer 185, a bottom electrode layer 184, a piezoelectric layer 183, a bottom electrode layer 182, and a protective layer 181 which are stacked together.

The support layer 185 may be made of SOI (Silicon On Insulator). The support layer 185 may be made of silicon dioxide or another insulating material.

The bottom electrode layer 184 may be made of platinum.

The piezoelectric layer 183 may be made of PZT (Lead Zirconate Titanate). Since the PZT membrane has a higher piezoelectric constant, the mechanic-electrical conversion efficiency can be enhanced, whereby the speaker drive ratio is improved.

The top electrode layer 182 may be made of gold and platinum alloy. The protective layer 181 may be made of silicon nitride.

Optionally, referring to FIG. 5, one insulative layer 159 is further provided between the first diaphragm structure 151 and the first substrate 153; the insulative layer 159 is made of silicon dioxide, which reduces the parasitic capacitance between the first diaphragm structure 151 and the first substrate 153 compared with a structure without an insulative layer.

It is noted that, the plurality of sub-diaphragms illustrated in FIGS. 2-8 in this implementation are all identical in size and shape. In other implementations, it may also be set that the plurality of sub-diaphragms have different sizes and shapes dependent on actual needs.

A layer of insulating adhesive 107 is provided between the first diaphragm structure 151 and the circuit board 110; the insulating adhesive has a through-hole in which a first electrically conductive metallic layer 108 may be accommodated, the first electrically conductive metallic layer 108 being configurable to connect the first electrode connection point 113 of the circuit board 110 and a third electrode connection point on the first diaphragm structure 151.

In this implementation, the insulating adhesive 107 may be made of silica gel. The first electrically conductive metallic layer 108 may be made of conductive adhesive, e.g., silver adhesive.

Optionally, the first flexible structure layer 157 is spaced apart from the support layer 185, with the piezoelectric layer of the first diaphragm structure disposed there between. The first flexible structure layer 157 has a complete sheet structure without interruptions; the first flexible structure layer 157 completely covers the slit 155 so that the overall structure of the first MEMS speaker 150 is free of micro-gaps, offering an outstanding mid-high frequency performance.

The first flexible structure layer 157 includes at least one organic thin film layer. The first flexible structure layer 157 has a Young's modulus less than that of the piezoelectric diaphragm. The Young's modulus of the first flexible structure layer 157 is in a range from 100 MPa to 50 GPa.

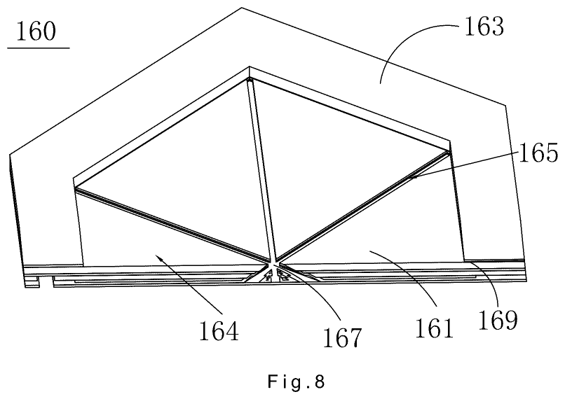

Referring to FIGS. 7 and 8, the second MEMS speaker 160 further includes: a second substrate 163 enclosing the second cavity 164, a second diaphragm structure 161 stacked on top the second substrate 163 and covering the second cavity 164, and a second flexible structure layer 167 overlaid on the second diaphragm structure 161; the second diaphragm structure 161 is a piezoelectric compound diaphragm.

The second diaphragm structure 161 includes a plurality of second sub-diaphragms 1611, a second slit 165 being arranged between adjacent second sub-diaphragms 1611. Each of the second sub-diaphragms 1611 has a three-dimensional isosceles triangle structure, respective vertices of the six isosceles triangles facing the central point of the second substrate 163 and enclosing a hexahedral structure, respective bottom edges of the isosceles triangles being rested on the second substrate 163.

One second insulating layer 169 is further arranged between the second diaphragm structure 161 and the second substrate 163. A layer of insulating adhesive 107 is arranged between the second diaphragm structure 151 and the circuit board 110; the insulating adhesive 107 has a through-hole in which a second electrically conductive metallic layer 118 may be accommodated, the second electrically conductive metallic layer 118 being configurable to connect a second electrode connection point of the circuit board 110 and a fourth electrode connection point 162 on the second diaphragm structure 161.

It is noted that, the second diaphragm structure 161, the fourth electrode connection point 162, the second substrate 163, and the second flexible structural layer 167 in the second MEMS speaker 160 may refer to the descriptions of the first diaphragm structure 151, the third electrode connection point, the first substrate 153, and the first flexible structural layer 157 in the first MEMS speaker 150, which are not detailed here.

In one example, the structure of the first MEMS speaker is different from that of the second MEMS speaker; the structure of the first MEMS speaker is, for example, identical to the first MEMS speaker 150 illustrated supra, while the structure of the second MEMS speaker is a known speaker to those skilled in the art.

In another example, the structure of the first MEMS speaker is different from that of the second MEMS speaker. The structure of the second MEMS speaker is for example identical to the second MEMS speaker 160 illustrated supra, while the structure of the first MEMS speaker is a known speaker to those skilled in the art.

In a further example, the first MEMS speaker 150 and the second MEMS speaker 160 have a same structure.

The design based on the first MEMS speaker 150 and the second MEMS speaker 160 in the speaker module enables simultaneous driving the first MEMS speaker 150 and the second MEMS speaker 160, so that the vibration direction of the first diaphragm structure 151 in the first MEMS speaker 150 is opposite the vibration direction of the second diaphragm structure 161 in the second MEMS speaker 160; as such, the sound wave produced by the first MEMS speaker 150 pushing the air is superimposed, at the sound outlet hole 102, with the sound wave produced by the second MEMS speaker 160 pushing the air, which then may produce a higher sound pressure level, e.g., a 2 dB˜6 dB sound pressure level.

When the first signal received by the first MEMS speaker 150 and the second signal received by the second MEMS speaker 160 are controlled separately, the corresponding electrical signals may drive the first MEMS speaker 150 and the second MEMS speaker 160 separately so that at some frequency bands, the vibration direction of the first diaphragm structure 151 is opposite the vibration direction of the second diaphragm structure 161 to superimpose the sound waves; at other frequency band, the vibration direction of the first diaphragm structure 151 is consistent with the vibration direction of the second diaphragm structure 161, which results in sound wave cancellation; in this way, a more flexible control is achieved.

It is noted that, the implementations described supra only illustrate various features of the first MEMS speaker, where the features in the second MEMS speaker are not explained in detail. The second MEMS speaker is consistent with the first MEMS speaker so that the second MEMS speaker may refer to the features of the first MEMS speaker, which are thus not detailed here.

A person of normal skill in the art may understand, the implementations described supra are only specific examples of implementing the present disclosure; in actual applications, various modifications may be made in form and details without departing from the spirits and scope of the present disclosure.

I/We claim:

1. A speaker module, comprising:
a housing enclosing a cavity, the housing having a sound outlet hole running through a thickness of the housing;
a circuit board disposed in the cavity, the circuit board having a first surface and a second surface which are oppositely set, the first surface having a first electrode connection point, the second surface having a second electrode connection point;
a first MEMS (Micro-Electro Mechanical System) speaker disposed in the cavity, the first MEMS speaker being mounted on the first surface in a flipped manner, the first MEMS speaker comprising a first diaphragm structure, the first diaphragm structure being electrically connected to the first electrode connection point, the first diaphragm structure being controlled by the circuit board to vibrate;
and a second MEMS (Micro-Electro Mechanical System) speaker disposed in the cavity, the second MEMS speaker being mounted on the second surface in a flipped manner, the second MEMS speaker comprising a second diaphragm structure, the second diaphragm structure being electrically connected to the second electrode connection point, the second diaphragm structure being controlled by the circuit board to vibrate.

2. The speaker module according to claim 1, wherein the first MEMS speaker further comprises: a first substrate enclosing a first cavity, the first diaphragm structure stacked on top of the first substrate and covering the first cavity, and a flexible structure layer overlaid on the first diaphragm structure; and the first diaphragm structure is a piezoelectric compound diaphragm.

3. The speaker module according to claim 1, wherein the second MEMS speaker further comprises: a second substrate enclosing a second cavity, the second diaphragm structure stacked on top of the second substrate and covering the second cavity, and a flexible structure layer overlaid on the second diaphragm structure; and the second diaphragm structure is a piezoelectric compound diaphragm.

4. The speaker module according to claim 2, wherein the first diaphragm structure comprises a plurality of sub-diaphragms, a slit being present between adjacent sub-diaphragms; and the first flexible structure layer covers the slit completely.

5. The speaker module according to claim 4, wherein an underside of the first substrate has a three-dimensional hexagonal structure; and an underside of the first diaphragm structure has a three-dimensional hexagonal structure.

6. The speaker module according to claim 5, wherein the first diaphragm structure comprises six sub-diaphragms, each of the sub-diaphragms having a polygonal structure extending from an edge of the first substrate towards a central point of the first substrate, top portions of the six polygonal structures facing the central point, a bottom edge of each of the polygonal structures being rested on the first substrate.

7. The speaker module according to claim 6, wherein each polygonal structure is a three-dimensional isosceles triangle structure, a vertex of each isosceles triangle pointing the central point.

8. The speaker module according to claim 2, wherein the first flexible structure layer is an organic thin film layer.

9. The speaker module according to claim 2, wherein the first diaphragm structure comprises a support layer, a bottom electrode layer, a piezoelectric layer, a top electrode layer, and a protective layer which are stacked together; and the support layer is spaced apart from the first flexible structure layer.

10. The speaker module according to claim 1, wherein a through-hole is provided in a center of the circuit board, and the through-hole has a polygonal or circular shape.
